(19) United States
(12) Patent Application Publication
(10) Pub. No.: US 2022/0212772 A1
(43) Pub. Date: Jul. 7, 2022

(54) AIRFRAME LOCALIZED KEEL STRUCTURES

(71) Applicant: General Electric Company, Schenectady, NY (US)

(72) Inventors: Nicholas J. Kray, West Chester, OH (US); Nitesh Jain, Bengaluru (IN); Abhijeet Jayshingrao Yadav, Bengaluru (IN)

(21) Appl. No.: 17/141,899

(22) Filed: Jan. 5, 2021

(51) Int. Cl. B64C 1/06; B64C 5/06; B64D 27/02

(52) U.S. Cl. CPC B64C 1/062; B64C 5/06; B64C 2001/0072; B64D 27/02; B64C 1/063

(57) ABSTRACT

Airframe localized keel structures are disclosed. An example aircraft includes an airframe, a first engine mounted on a first side of the airframe, a second engine mounted on a second side of the airframe, and an airframe keel positioned on at least one of a lower portion of the airframe or an upper portion of the airframe between the first engine and the second engine, the airframe keel to prevent an object from exiting the first engine and impacting the second engine.

### FIELD OF THE DISCLOSURE

This disclosure relates generally to aircraft, and, more particularly, to airframe localized keel structures.

### BACKGROUND

Aircraft sometimes encounter situations that endanger the thrust capabilities of associated propellers, such as when a fan blade of a propeller is released from an associated retention disk (e.g., a fan blade out condition). A thrust capability of the aircraft is vital to the functions of the aircraft and the safety of its passengers. As such, aircraft are able to fly using the thrust of a single propeller in case another propeller is compromised.

### BRIEF DESCRIPTION

Localized keel structures for wings and/or airframes are disclosed.

Certain examples provide an example aircraft including an airframe, a first engine mounted on a first side of the airframe, a second engine mounted on a second side of the airframe, and an airframe keel positioned on at least one of a lower portion of the airframe or an upper portion of the airframe between the first engine and the second engine, the airframe keel to prevent an object from exiting the first engine and impacting the second engine.

Certain examples provide an example aircraft including an airframe, engines mounted on opposite sides of the airframe, the engines not including containment systems, and a keel disposed between the engines on an upper surface of the airframe or a lower surface of the airframe, the keel to deflect objects traversing a portion of the airframe.

Certain examples provide an apparatus including a body, a first means for propulsion positioned on a first side of the body, a second means for propulsion positioned on a second side of the bod opposite the first side, the second means for propulsion aligned with the first means for propulsion, at least one of the first means for propulsion or the second means for propulsion not including a containment system, and means for deflecting extending from a lower surface of the body or an upper surface of the body between the first means for propulsion and the second means for propulsion, the means for deflecting to deflect objects traversing at least a portion of the body.

### BRIEF DESCRIPTION OF THE DRAWINGS

FIGS. 1A-B illustrate prior art aircraft.

FIG. 2 illustrates a fan blade out condition analysis of the prior art aircraft of FIGS. 1A-B.

FIGS. 3A-B illustrate an aircraft including an example airframe localized keel structure.

FIGS. 4A-C illustrate example cross-sections of the aircraft of FIG. 3A.

FIGS. 5A-B illustrate a frontal view of the aircraft of FIG. 3B including a first implementation the airframe localized keel structure.

FIG. 6 illustrates a fan blade out condition analysis of the aircraft of FIGS. 3 and 5.

FIG. 7 illustrates an aircraft including a second implementation of the airframe localized keel structure of FIGS. 5A-B.

FIG. 8 illustrates an example 4-engine including wing keels and the airframe localized keel structure of FIGS. 3A-B, 4, 5A-B, and/or 6.

The figures are not to scale. As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Federal Aviation Administration (FAA) regulation 33.94 requires a turbofan engine of an aircraft to safely demonstrate a blade release from an associated retention disk (e.g., a fan blade out condition). For example, the blade cannot pierce a fuselage (e.g., an airframe, a body, etc.) or interfere with operations of another component of the aircraft, such as a second engine. Aircraft can continue to propel their flight using a single functioning propeller even if another propeller on the aircraft is inoperative (e.g., defective, broken, unable to produce thrust, etc.). However, if all propellers of the aircraft are inoperative, the aircraft is unable to produce thrust, which forces the aircraft to pursue an emergency landing. As such, it is essential that a failure of a first engine of an aircraft does not affect a second engine of the aircraft.

In some examples of an engine with a containment system (e.g., closed rotor engines, ducted engines, etc.), a detached and/or broken blade may be held within a case that surrounds the engine. In other words, the detached and/or broken blade does not penetrate the case, which addresses the risk of the loose blade affecting another component outside the damaged engine. However, in some examples, the blade penetrates the case and ejects from a first engine (e.g., a damaged engine). In some such examples, the blade launches towards a second engine in line with the damaged engine. Specifically, a trajectory of the blade towards the second engine is in response to a rotation of the blade when it was attached to the first engine and a point of release (e.g., a break and/or detachment) of the blade during the rotation. In some examples, the trajectory of the blade impacts the second engine ingests the blade in response to the trajectory impacting or approaching the second engine. In some such example, the second engine also becomes inoperative leaving the aircraft without any means for propulsion.

Aircraft today typically utilize engine propellers with closed rotor configurations. However, implementations of engines without containment systems (e.g., propfans, open rotor engines, unducted engines, etc.) has become increasingly desirable as they address some of the concerns associated with closed rotor engines. For example, engines without containment systems provide a better fuel efficiency and produce reduced emissions compared to closed rotor engines. As such, engines without containment systems address some concerns associated with closed rotor engines, such as fuel prices, energy security, and/or the environment.

In an engine without a containment system, there is no case, shield, or other restraint to retain a loose fan blade, or a portion thereof, after it is released from the retention disk (e.g., due to stress, foreign object, other failure, etc.). Further, the rotation of the retention disk can propel the loose fan blade towards another engine on the aircraft. As a result, the loose fan blade can contact exposed rotor blades of the other engine, rendering both engines inoperative, which presents a catastrophic risk to the aircraft.

To address the risks presented by the fan blade out condition, examples disclosed herein include airframe localized keel structures (e.g., a keel, an airframe keel, a wing keel, a keel apparatus, etc.). In some examples, engines (e.g., engines including containment systems, engines not including containment systems, etc.) of an aircraft are mounted on an airframe and/or on opposite sides thereof. In some such examples, the keel is disposed between the engines to prevent objects from traversing between them. Specifically, the keel deflects objects, such as loose fan blades and/or portion(s) thereof, that travel between the engines. For example, if a first engine loses a fan blade, the keel can prevent the fan blade from crossing the airframe and impacting a second engine. Further, if the first and second engines are mounted on a same wing, the keel can be positioned on the wing to obstruct objects traveling between the engines. As a result, when a fan blade is released from the first or second engine, the keel can block the fan blade from impacting the other engine.

In some examples, the keel is integral to a portion of an aircraft, such as the airframe and/or the wing. In some examples, the keel is a separate part that is mounted onto the airframe and/or the wing via mechanical fasteners (e.g., screws, bolts, etc.) and/or adhesives. In some examples, the keel includes one or more openings through which the mechanical fasteners can be inserted. Further, the airframe can include openings on a surface thereof that correspond with the openings of the keel. As such, the mechanical fasteners can couple the keel to a surface of the airframe. In some examples, the mechanical fasteners and associated openings are countersunk into the airframe to minimize drag.

In some examples in which at least a portion of the engines are positioned below the airframe, the keel is positioned on a lower surface of the airframe in response to at least a portion of the engines being positioned below the airframe. In some examples in which at least a portion of the engines are positioned above the airframe, the keel is positioned on an upper surface of the airframe. For example, the keel can be positioned on a lower portion of the airframe and/or the wings when the engines are mounted on a bottom surface of wings of the aircraft. Further, the keel can be positioned on an upper portion of the airframe and/or the wings when the engines are mounted on a top surface of the wings. Although examples disclosed herein describe engines mounted on opposite sides of the airframe, the keel can be positioned between engines mounted anywhere on the aircraft, such as the top and/or bottom of the airframe.

In some examples, the keel is aligned with a plane of rotation of fan rotors of the engines. In some such examples, a length of the keel extends along the airframe at least 15 degrees from each side of the plane of rotation of the fan rotors. In some examples, a height of the keel is less than or equal to a diameter of the fan rotors of the engines to minimize unnecessary drag forces on the aircraft. In some examples, the keel is foldable, collapsible, retractable, and/or detachable from the aircraft. As such, the keel does not interfere with a landing of the aircraft that may occur when landing gear cannot be deployed due to a failure and/or malfunction.

The keel provides shielding that prevents cross-engine damage. As a result, the keel maintains the functionality of one engine even if another engine were to lose a fan blade, which further addresses FAA regulatory requirement 33.94. In some examples, the keel prevents other objects besides fan blades from traversing the airframe and colliding with one of the engines. In some examples, the airframe includes additional shielding to prevent the fan blade from piercing it as described in U.S. patent Publication Ser. No. 17/071,114, U.S. patent Publication Ser. No. 17/071,379, and U.S. patent Publication Ser. No. 17/071,308, which are hereby incorporated as references in their entirety.

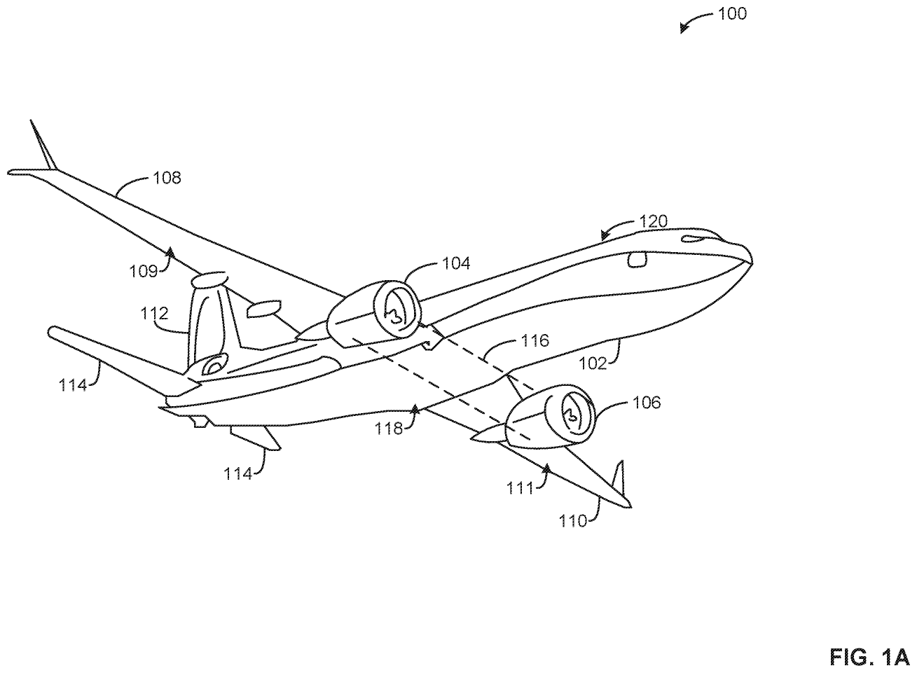

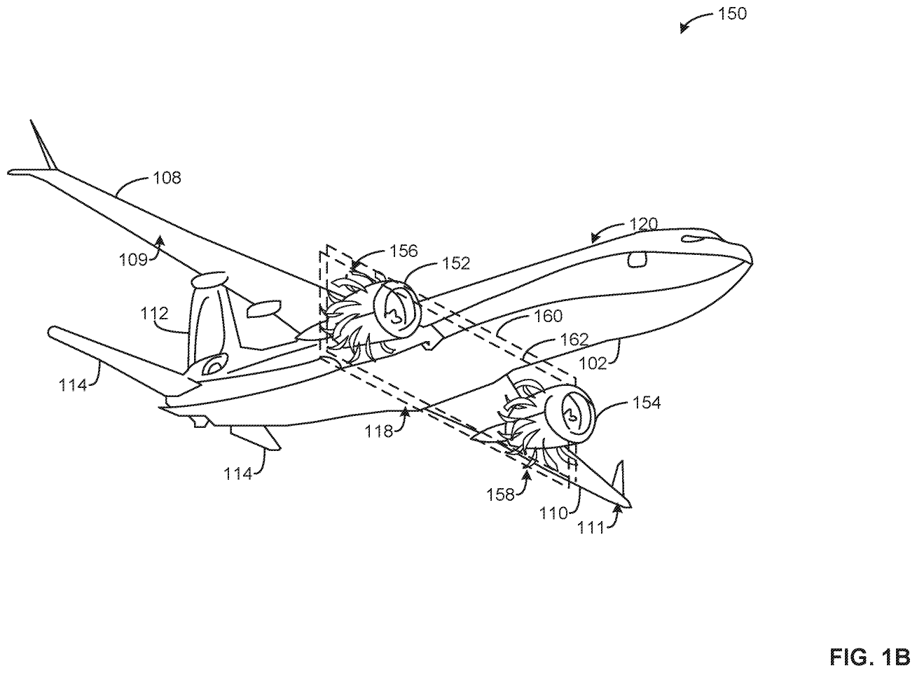

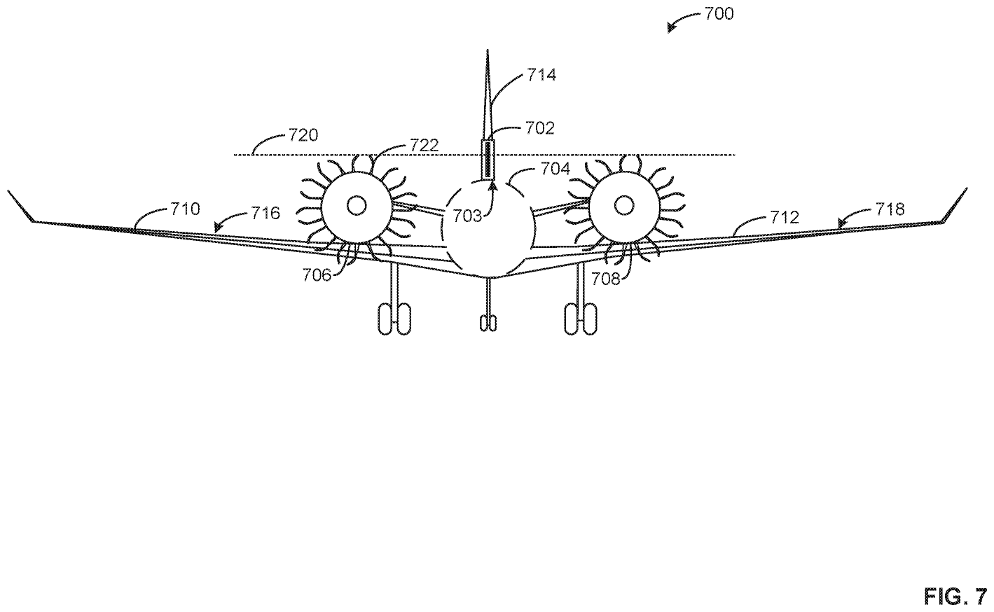

FIG. 1A illustrates a first example prior art aircraft 100 that utilizes a first engine (e.g., a right engine) 104 and a second engine (e.g., a left engine) 106, which both include containment systems. In FIG. 1A, the aircraft 100 includes an airframe (e.g., a fuselage) 102, a right wing 108, a left wing 110, a vertical stabilizer 112, horizontal stabilizers 114, and a blade rotation plane (e.g., a plane of rotation of fan rotors of the first engine 104 and the second engine 106) 116. In FIG. 1A, the first engine 104 and the second engine 106 include containment systems. However, in some examples, the containment systems of the first and second engine 104, 106 are unable to prevent a loose blade from slicing through and/or ejecting therefrom. In FIG. 1A, the first engine 104 is mounted on a bottom surface 109 of the right wing 108 and the second engine 106 is mounted on a bottom surface 111 of the left wing 110. In some other examples, the right and left engines 104, 106 are mounted on a top surface of the right and left wings 108, 110, as discussed further in association with FIG. 7. In some other examples, the right engine 104 and the left engine 106 are mounted on the airframe 102 and/or a bottom surface of the horizontal stabilizers 114.

In FIG. 1A, the blade rotation plane 116 aligns with the fan rotors of the first and second engines 104, 106. Further, the blade rotation plane 116 spans across a bottom surface 118 of the airframe 102. In other examples, the blade rotation plane 116 spans across a top surface 120 of the airframe 102. The aircraft 100 can include more than one of the blade rotation plane 116, as discussed further in association with FIG. 1B. In FIG. 1A, the blade rotation plane 116 is unobstructed, which allows objects (e.g., loose blades, debris, etc.) to traverse the bottom surface 118 of the airframe 102 between the first engine 104 and the second engine 106.

As a result, if either the first engine 104 or the second engine 106 is struck by an object and/or loses a fan blade, both the first engine 104 and the second engine 106 can lose propulsion (e.g., thrust) capabilities. For example, a rapid rotation of the fan blades of the first engine 104 can launch a loose fan blade, or a portion thereof, through the containment system of the first engine 104, across the blade rotation plane 116. Further, the loose fan blade of the first engine 104 can travel through the containment system, or in the proximity, of the second engine 106 causing the second engine 106 to ingest the loose fan blade. As a result, the loose fan blade of the first engine 104 causes damage to the second engine 106. In FIG. 1A, both the first engine 104 and the second engine 106 may be unable to provide thrust and propel the aircraft 100 in response to the first engine 104 or the second engine 106 losing a fan blade or a portion thereof (e.g., a fan blade out condition).

FIG. 1B illustrates a prior art aircraft 150 including a first engine 152 and a second engine 154 that do not include containment systems (e.g., open rotor engines, propfans, unducted engines, etc.). In other words, blades (e.g., rotor blades, fan blades, etc.) 156 of the first engine 152 and blades 158 of the second engine 154 are exposed. Further, a first row of the blades 156, 158 of the first engine 152 and the second engine 154 are aligned along a first blade rotation plane 160, and a second row of the blades 156, 158 are aligned along a second blade rotation plane 162. In FIG. 1B, the second blade rotation plane 162 is disposed aft the first blade rotation plane 160.

In FIG. 1B, the first engine 152 and the second engine 154 are both at risk of losing thrust capabilities, and being unable to propel the aircraft 150, if either the first or second engine 152, 154 is impacted by an object and/or loses one of the blades 156, 158, or a portion thereof. Specifically, rotation of the blades 156, 158 of the first engine 152 and/or the second engine 154 can propel one of the blades 156, 158, or a portion thereof, that has detached from an associated retaining disk on a trajectory across the first or second blade rotation plane 160, 162. Further, the detached one of the blades 156, 158 can traverse the bottom surface 118 of the airframe 102 and strike the blades 156, 158 of the opposite engine 152, 154 rendering both the first engine 152 and the second engine 154 inoperative (e.g., broken, ineffective, defective, etc.).

In some other examples, the first engine 152 and/or the second engine 154 does not lose one of the fan blades 156, 158 in response to impact from an object. However, collision between the object and one the fan blades 156, 158 can propel the object towards the opposite engine 152, 154. As a result, the object can break off one of the fan blades 156, 158 of the opposite engine 152, 154, which again puts the aircraft 150 at risk of losing propulsion from both engines 152, 154 as the object and/or a detached one of the fan blades 156, 158 launch across the first or second blade rotation plane 160, 162.

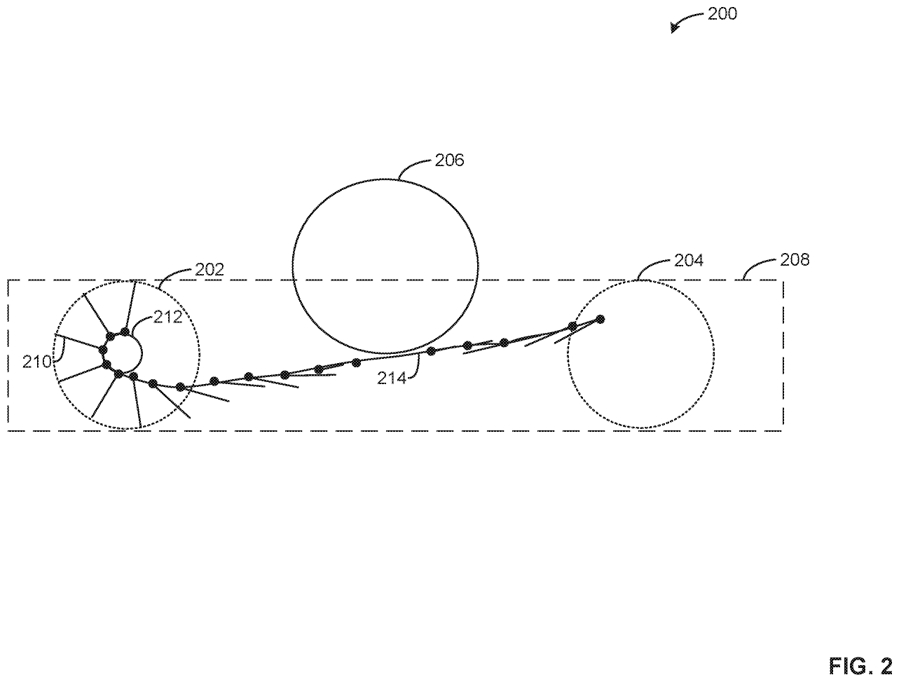

FIG. 2 illustrates a fan blade out condition simulation 200 of the first and/or second example prior art aircraft 100, 150 of FIGS. 1A and/or B. In FIG. 2, the fan blade out simulation 200 includes a first engine (e.g., the first engine 104, the first engine 152) 202 and a second engine (e.g., the second engine 106, the second engine 154) 204. In FIG. 2, the fan blade out simulation 200 further includes an airframe (the airframe 102 of FIGS. 1A and B) 206 and a blade rotation plane (e.g., the blade rotation plane 116, the blade rotation plane 160) 208. In FIG. 2, the fan blade out simulation 200 includes a blade (e.g., a fan blade, a rotor blade, etc.) 210 and a retention disk 212 of the first engine 202. Further, a release of the blade 210 from the retention disk 212 of the first engine 202 was simulated to determine a trajectory 214 that the blade 210 follows.

In FIG. 2, the blade 210 of the first engine 202 launches on the trajectory 214 across the blade rotation plane 208 below the airframe 206. For example, an external object may contact the blade 210, during a rotation thereof, causing the blade 208 to detach from the associated retention disk 212. In some other examples, wear and tear during operations of the first engine 202 causes a crack and/or other imperfections in the blade 210 and/or the retention disk 212, which eventually causes the blade 210 or a portion thereof to rupture and eject from the first engine 202. Further, the first engine 202 is unable to provide sufficient thrust in response to losing the fan blade 210 or a portion thereof.

In the example simulation 200 of FIG. 2, the blade 210 travels across the blade rotation plane 208 on the trajectory 214 in response to detachment from the retention disk 212 of the first engine 202. As a result, the blade 210 impacts the second engine 204, which can render the second engine 204 inoperative and remove thrust capabilities of the aircraft 100, 150. In some examples, fan blades of the second engine 204 are exposed, as shown in FIG. 1B. In some such examples, the blade 208 impacts the fan blades of the second engine 204 causing them to break and/or dislodge from the second engine 204. In some examples, the blade 208 pierces a containment system of the second engine 204, as discussed in association with FIG. 1A. In some such examples, the blade 208 and/or a portion of the pierced containment system can obstruct a rotation of the fan blades of the second engine 204, which results in an insufficient and/or nonexistent thrust being provided by the first engine 202 and the second engine 204. In other words, loss of the fan blade 210 of the first engine 202 jeopardizes propulsion capabilities of the aircraft 100, 150.

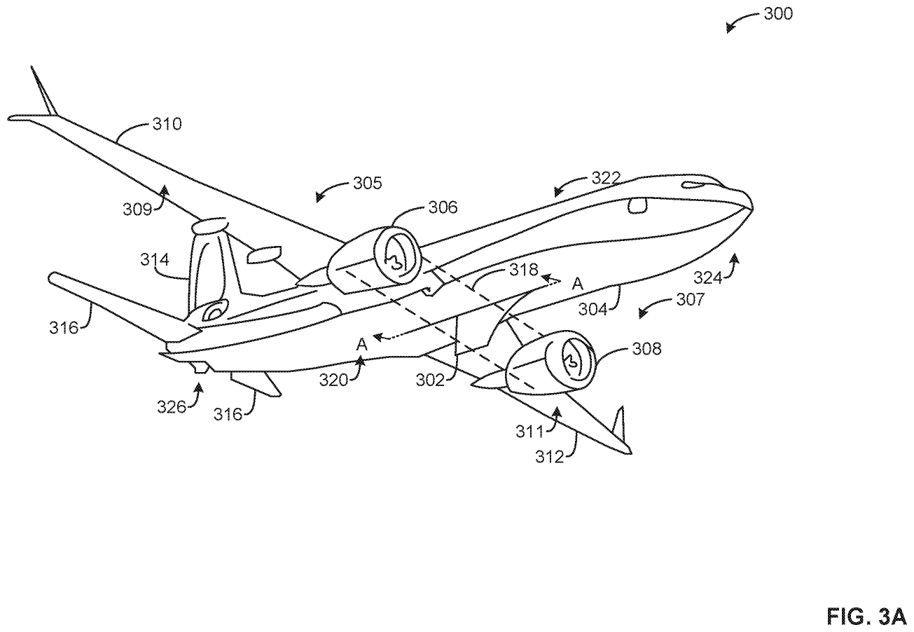

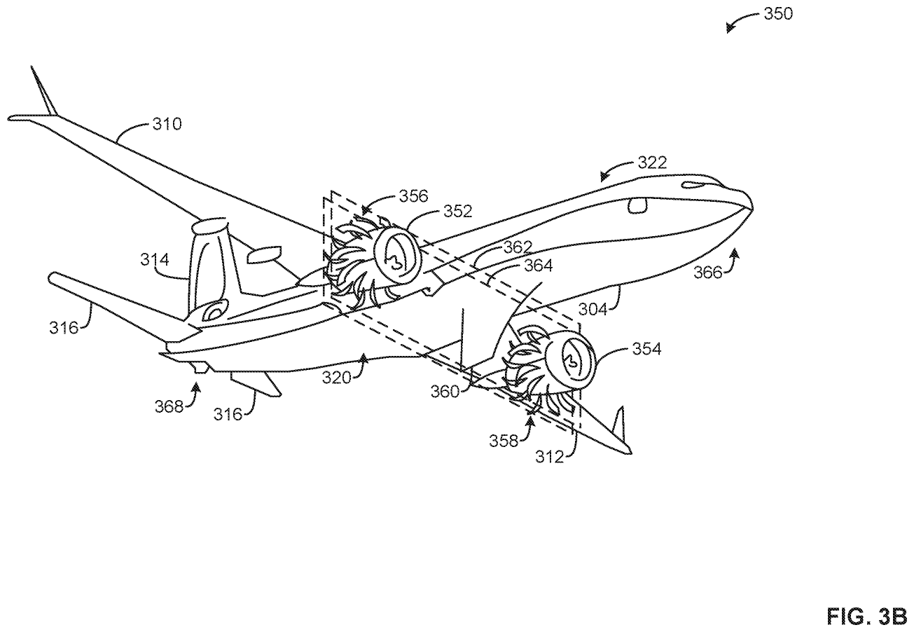

FIG. 3A illustrates an aircraft 300 including an airframe localized keel structure (e.g., a keel) 302. In FIG. 3A, the aircraft 300 includes a first engine (e.g., a right engine) 306 mounted on a first side 305 of an airframe 304 and a second engine (e.g., a left engine) 308 mounted on a second side 307 of the airframe 304. Specifically, the first engine 306 is mounted on a bottom surface 309 of a right wing 310 and the second engine 308 is mounted on a bottom surface 311 a left wing 312. In FIG. 3A, the aircraft 300 further includes a vertical stabilizer 314 and horizontal stabilizers 316 positioned on an aft portion of the airframe 304.

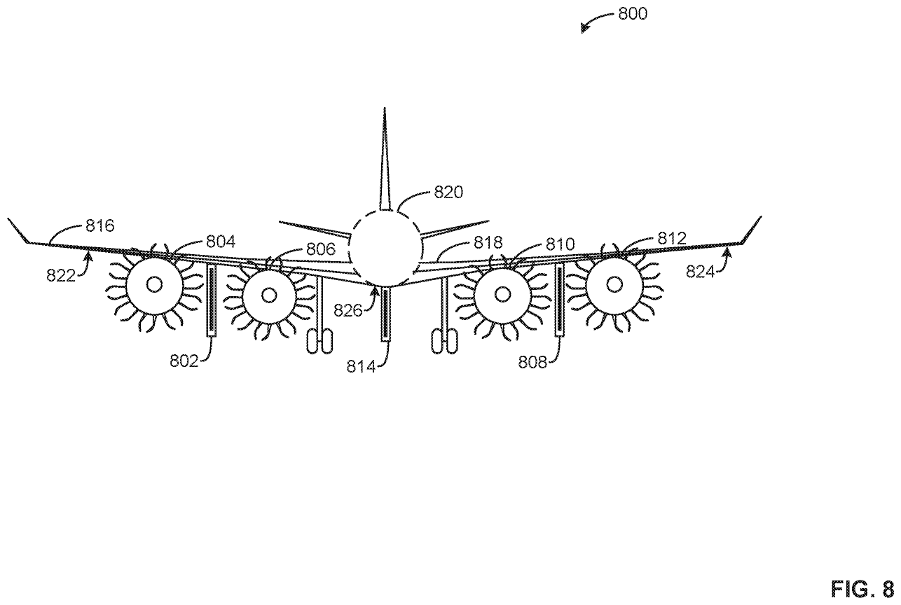

In FIG. 3A, the first engine 306 and the second engine 308 include containment systems that are unable to prevent penetration by a fan blade. In FIG. 3A, the keel 302 is positioned on a lower portion (e.g., a lower surface, a bottom surface, etc.) 320 of the airframe 304 between the first engine 306 and the second engine 308. In some other examples, the keel 302 is positioned between engines on an upper portion 322 of the airframe 304, the right wing 310, and/or the left wing 312, as discussed further in association with FIGS. 7 and 8. That is, the keel 302 can be positioned anywhere on the aircraft 300 in response to a location of the first engine 306, the second engine 308, and/or any other engines.

In FIG. 3A, the keel 302 is positioned in line with a plane of rotation 318 of fan rotors of the first engine 306 and the second engine 308. In FIG. 3A, the keel 302 extends longitudinally along a bottom surface 320 of the airframe 304 at least 15 degrees from each side of the plane of rotation 318 of the fan rotors of the first and second engine 306, 308. In other words, the keel 302 extends toward a fore end 324 of the airframe 304 at least 15 degrees from the plane of rotation 318 and also extends toward an aft end 326 of the airframe 304 at least from the plane of rotation 318. In FIG. 3A, a height of the keel 302 is equivalent to a diameter of the fan rotors of the first and second engine 306, 308. In some examples, the height of the keel 302 is less than the diameter of the fan rotors of the first and second engine 306, 308 in response to a portion of the blade rotation plane 318 intersecting the airframe 304.

In FIG. 3A, the keel 302 prevents an object (e.g., a fan blade) from exiting the first engine 306 and impacting the second engine 308. For example, if a fan blade of the first engine 306 exits the containment system thereof and traverses the plane of rotation 318, the keel 302 deflects the fan blade and prevents it from crossing the airframe 304 to protect the second engine 308. As such, the keel 302 provides shielding to allow the second engine 308 to propel the aircraft 300 regardless of if the first engine 306 loses a fan blade.

FIG. 3B illustrates an aircraft 350 including a first engine (e.g., a right engine) 352 and a second engine (e.g., a left engine) 354 mounted on opposite sides of the airframe 304. In FIG. 3B, the first engine 352 and the second engine 354 do not include a containment system. In other words, the first and second engines 352, 354 are open rotor engines with fan rotors (e.g., fan blades, rotor blades, etc.) 356, 358 that are exposed to the outside environment. In FIG. 3B, the first engine 352 is mounted on the right wing 310 and the second engine 354 is mounted on the left wing 312. In FIG. 3B, the aircraft 350 further includes the vertical stabilizer 314 and the horizontal stabilizers 316 of FIG. 3A.

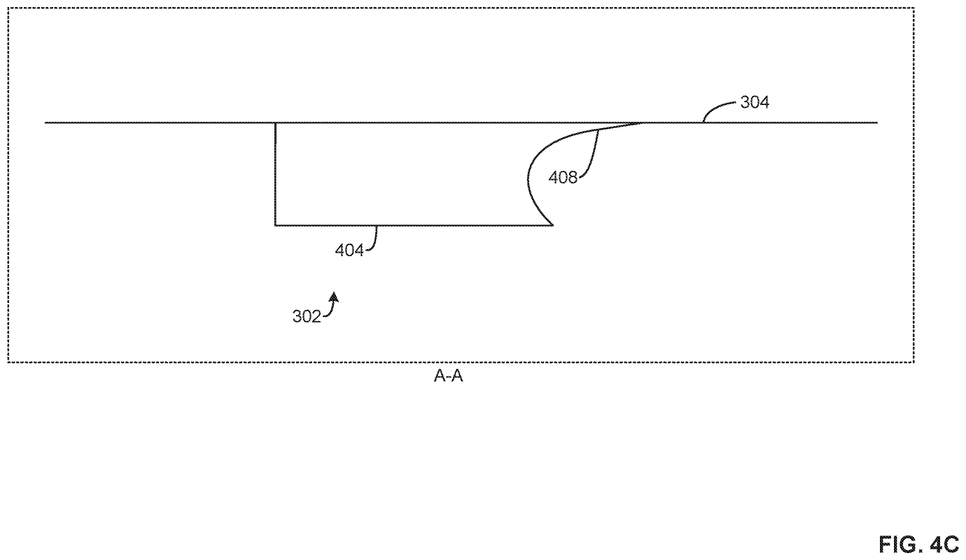

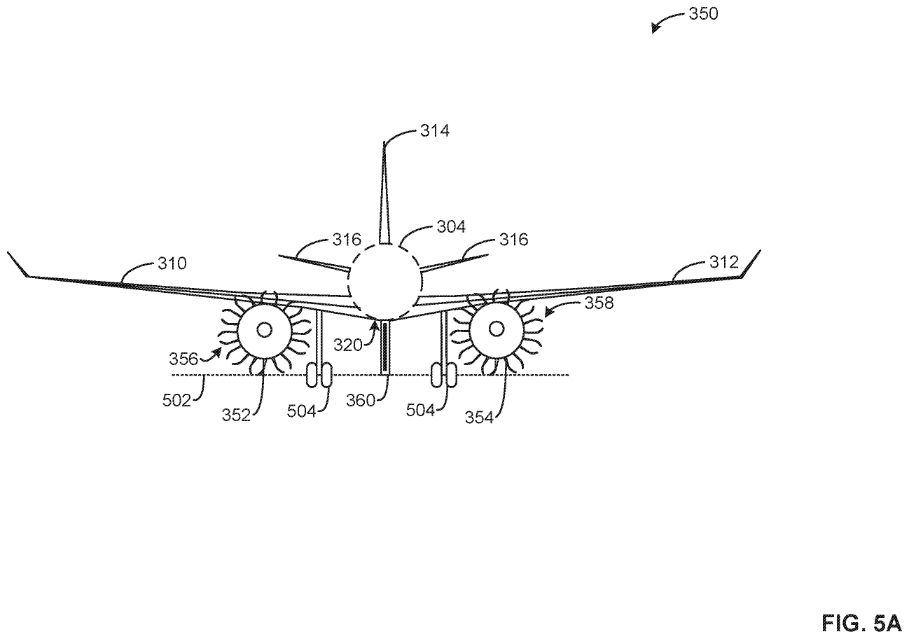

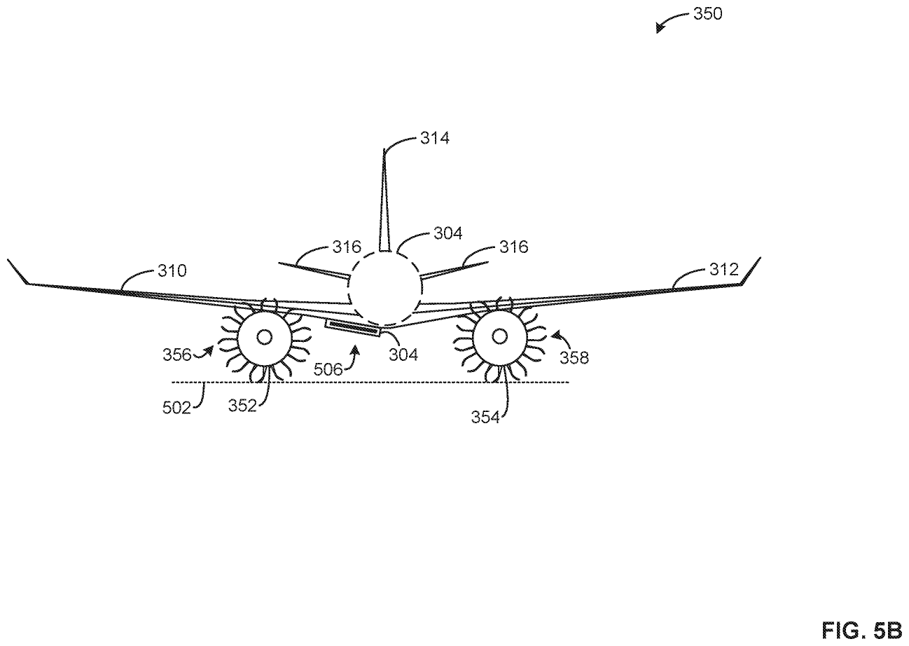

In FIG. 3B, a first row of the fan blades 356, 358 of the first and second engines is aligned along a first plane of rotation 362, and a second row of the fan blades 356, 358 is aligned a second plane of rotation 364. In FIG. 3B, the second plane of rotation 364 is disposed aft of the first plane of rotation 362. In FIG. 3B, a keel 360 is positioned on the bottom portion 320 of the airframe 304 between the first and second engines 352, 354. In some examples the keel 360 is foldable, collapsible, and/or retractable, as discussed further in association with FIG. 5B. In FIG. 3B, the keel 360 intersects the first and second plane of rotation 362, 364 of the first and second rows of the fan blades 356, 358. In FIG. 3B, the keel 360 extends along the bottom portion 320 of the airframe 304 at least 15 degrees from the first plane of rotation 362 towards a fore end 366 of the airframe 304 and at least 15 degrees from the second plane of rotation 364 towards an aft end 368 of the airframe 304, for example.

In some examples, the keel 360 is substantially perpendicular (e.g., plus, or minus 10 degrees) to the first and second planes of rotation 362, 364 to prevent objects from crossing a portion of the airframe 304. As a result, when the second engine 354 or the first engine 352 loses one of the respective fan rotors 356, 358, the keel 360 protects the first engine 352 or the second engine 354, respectively, from being obstructed. As used herein in the context of describing the position and/or orientation of a first object relative to a second object, the term “substantially perpendicular” encompasses the term perpendicular and more broadly encompasses a meaning whereby the first object is positioned and/or oriented relative to the second object at an absolute angle of no more than ten degrees (10°) from perpendicular. For example, a first axis that is substantially perpendicular to a second axis is positioned and/or oriented relative to the second axis at an absolute angle of no more than ten degrees (10°) from perpendicular.

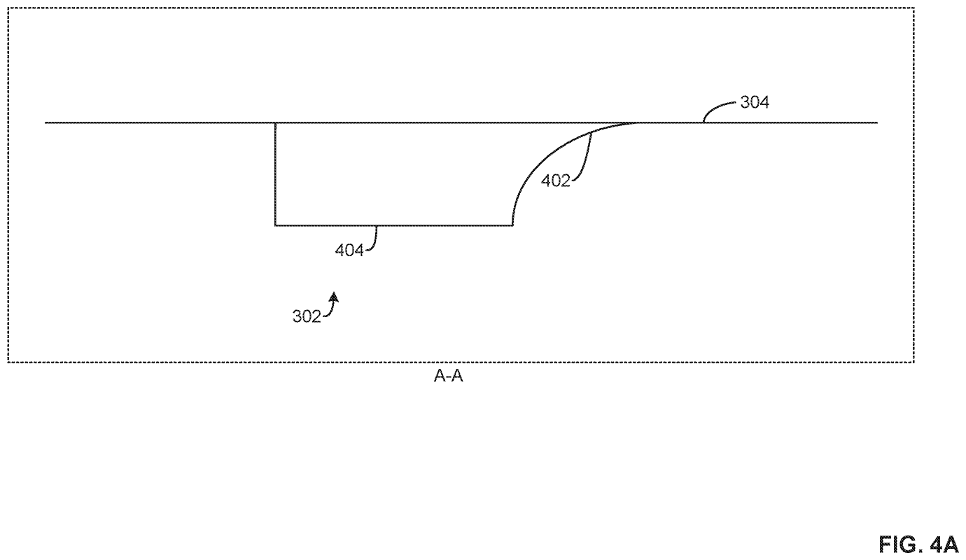

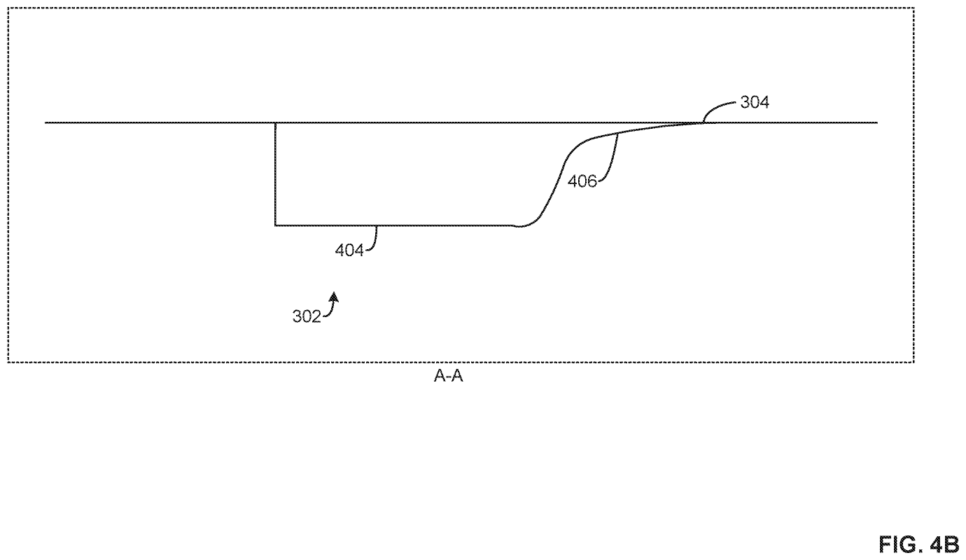

FIG. 4A illustrates a first example cross-section A-A of the aircraft 300 of FIG. 3A to more clearly illustrate the airframe localized keel structure 302. In FIG. 4A, the cross-section A-A can also be representative of the keel 360 of the aircraft 350 of FIG. 3B as the difference between the keel 302 of FIG. 3A and the keel 360 of FIG. 3B is the size thereof. In FIG. 4A, the keel 302 includes a first aerodynamic section 402 and a protection section 404. In FIG. 4A, the first aerodynamic section 402 and/or the protection section 404 includes an energy absorbing material, such as a foam honeycomb with a composite skin. In FIG. 4A, the protection section 404 of the keel 302 is disposed aft of the aerodynamic section 402. In FIG. 4A, the protection section 404 includes a rectangular cross-section. In FIG. 4A, a first end (e.g., a trailing edge, an aft end, etc.) of the first aerodynamic section 402 is fixed to a leading edge of the protection section 404. In FIG. 4A, a second end (e.g., a leading end, a fore end, etc.) of the first aerodynamic section 402 includes a reduced height relative to the protection section 404. In FIG. 4A, a contour of the first aerodynamic section 402 includes an arc between the first end and the second end. As a result, the first aerodynamic section 402 reduces a drag force on the aircraft 300 caused by the keel 302. In some examples, the second end of the first aerodynamic section 402 includes a smaller thickness than the protection section 404 to further reduce the drag force on the aircraft 300 caused by the keel 302. For example, the keel 302 can be tapered to include a smaller width (e.g., thickness) at a leading edge (e.g., a fore end of the keel 302) compared to a trailing edge (e.g., an aft end of the keel 302). In some examples, the keel 302 is tapered to include a width that decreases away from the airframe 304 (e.g., towards a bottom edge of the keel) to reduce the drag force on the aircraft 300 caused by the keel 302.

In FIG. 4A, the protection section 404 extends along the airframe 304 at least 15 degrees from each side of the plane of rotation 318 of the fan blades of the first and second engine 306, 308. Further, a uniform height of the protection section 404 relative to the airframe 304 is equivalent to a diameter of the fan blades of the first and second engine 306, 308. As a result, the protection section 404 prevents objects from traversing a portion of the airframe 304 to protect the first and second engines 306, 308 and, thus, the propulsion capabilities of the aircraft 300. In other words, the protection section 404 prevents a fan blade from exiting the first engine 306 and impacting the second engine 308. Damage to the second engine 308 can be avoided, and the second engine 308 can continue to operate, sustaining lift and velocity of the aircraft.

FIG. 4B illustrates a second example cross-section A-A of the aircraft 300 of FIG. 3A to more clearly illustrate the airframe localized keel structure 302. In FIG. 4B, the cross-section A-A can also be representative of the keel 360 of the aircraft 350 of FIG. 3B. In FIG. 4B, the keel includes the protection section 404 of FIG. 4A and a second example aerodynamic section 406. In FIG. 4B, the second aerodynamic section 406 includes a first end fixed to a leading edge of the protection section 404 and a second end extending away from the protections section 404. In FIG. 4B, the second aerodynamic section 406 includes more than one arc between the first end and the second end resulting in a double inflection contour that reduces the drag force on the aircraft 300 caused by the protection section 404. That is, a first arc of the second aerodynamic section 406 extends past a height of the protection section 404 and a second arc of the second aerodynamic section 406 extends a length of the second aerodynamic section 406 away from the protection section 404 at a reduced height compared to the protection section 404. As a result, the second protection section 406 reduces the drag force on the aircraft 300 caused by the protection section 404

FIG. 4C illustrates a third example cross section A-A of the aircraft 300 of FIG. 3A to more clearly illustrate the airframe localized keel structure 302. In FIG. 4C, the cross-section A-A can also be representative of the keel 360 of the aircraft 350 of FIG. 3B. In FIG. 4B, the keel 302 includes the protection section and a third example aerodynamic section 408. In FIG. 4C, the third aerodynamic section 408 includes a first end, a second end, and at least one arc therebetween. In FIG. 4C, the at least one arc of the third aerodynamic section 408 extends toward the protection section 404 to reduce the drag force on the aircraft 300 caused by the protection section 404.

FIG. 5A illustrates a frontal view of the aircraft 350 of FIG. 3B. In FIG. 5A, the keel 360 extends from the bottom portion 320 of the airframe 304 to a lowermost position 502 of the fan rotors 356, 358 of the first engine 352 and the second engine 354. In FIG. 5A, the aircraft 350 further includes landing gear 504 in a deployed position. In FIG. 5A, a height of the keel 302 is less than a diameter of the fan rotors 356, 358 of the first and second engine 306, 308. Specifically, a top of the fan rotors 356, 358 of the first and second engines 306, 308 is aligned with the airframe 304 and, thus, is above a top of the keel 360. As a result, the airframe 304 shields the first and second engines 352, 354 if a release of one of the fan rotors 356, 358 is on a trajectory above the keel 360. As such, if one the fan rotors 356, 358, or a portion thereof, detaches from the respective engine 352, 354, the detached fan rotor 356, 358 is unable to obstruct the opposite engines 352, 354. In FIG. 5A, the keel 360 extends from the bottom portion 320 of the airframe 304 to align with the lowermost position 502 of the first and second engines 306, 308. In some examples, the keel 360 extends from the airframe 304 to align with an uppermost position of the first and second engines 306, 308, as discussed further in association with FIG. 7. In some examples, the first engine 352 and the second engine 354 are positioned on the airframe 304 and/or the horizontal stabilizers 316. In some such examples, the first and second engine 352, 354 are at least partially external to a cross-sectional area or the airframe 304. Further, the keel 360 is positioned on the aircraft 350 in response to a position of the first and second engines 352, 354, for example.

In some examples, the keel 302 includes an energy absorbing material, such as a foam honeycomb with a composite skin. As a result, the keel 302 absorbs the impact of the rotor blades 356 and/or any other object traversing between the first engine 306 and the second engine 308. Further, the energy absorption of the keel 302 prevents the rotor blades 356 from traversing the airframe 304 and/or affecting the opposite engine 306, 308.

FIG. 5B illustrates a frontal view of the aircraft 350 of FIGS. 3B and/or 5A with the keel 360 in a collapsed (e.g., folded, retracted, etc.) position 506. In some examples, the aircraft 350 lands without utilizing the landing gear 504 due to a failure or malfunction thereof. As such, the landing gear 504 of FIG. 5A is not shown in FIG. 5B to illustrate the failure thereof. In some such examples, the keel 360 folds, retracts, and/or collapses into the collapsed position 506 to avoid interfering with a landing and inflicting damage on the aircraft 350. In some other examples, the keel 360 detaches from the airframe 304.

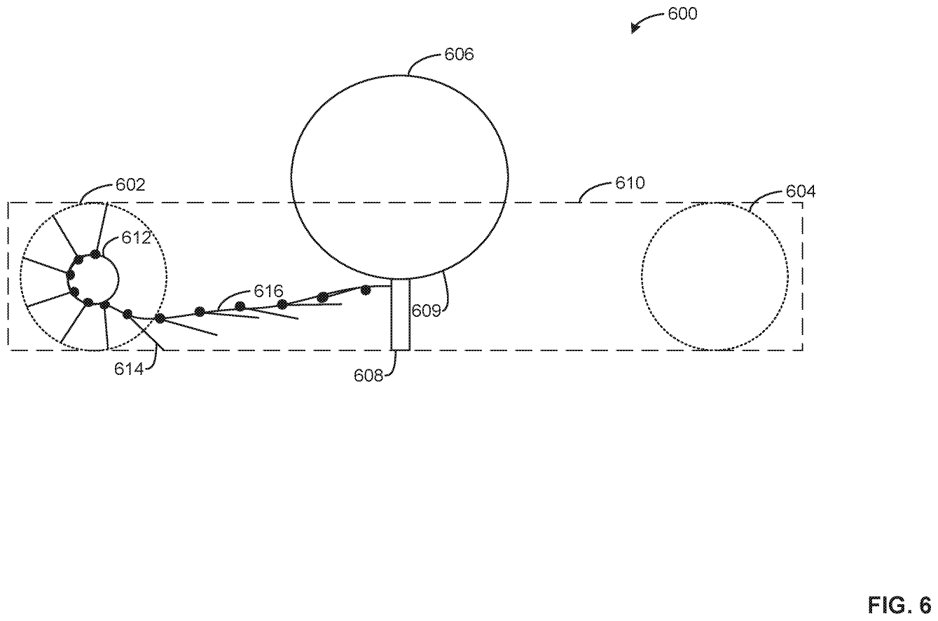

FIG. 6 illustrates a fan blade out simulation 600 of the aircraft 300 of FIG. 3A or the aircraft 350 of FIGS. 3B and/or 5A. In FIG. 6, the fan blade out simulation 600 includes a first engine (e.g., the first engine 306, the first engine 352) 602 and a second engine (e.g., the second engine 308, the second engine 354) 604 disposed on opposite sides of an airframe (e.g., the airframe 304) 606. In FIG. 6, the fan blade out simulation 600 further includes a keel (e.g., the keel 302, the keel 360) 608 extending from a lower surface 609 of the airframe 606 and a blade rotation plane (e.g., the plane of rotation 318, the first plane of rotation 362, the second plane of rotation 364, etc.) 610 of rotor blades of the first and second engine 602, 604. In FIG. 6, the first engine 602 further includes a retention disk 612 and a fan blade (e.g., one of the fan blades 356) 614 that detaches from the retention disk 612 and follows a trajectory 616.

In FIG. 6, the trajectory 616 of the fan blade 614 is similar to a beginning portion of the trajectory 214 of FIG. 2. However, in FIG. 6, the keel 608 interferes with the trajectory 616 as the fan blade 614 traverses the airframe 606. As a result, the keel 608 preserves thrust capabilities of the second engine 604. Specifically, the keel 608 obstructs the blade rotation plane 610 and extends at least 15 degrees from each side thereof to prevent objects, such as the fan blade 614, from traversing a portion of the airframe 606 that may otherwise lead to impacting the second engine 604, for example. As a result, the keel 608 deflects the fan blade 614 and, thus, prevents the fan blade 614 from exiting the first engine 602 and impacting the second engine 604.

FIG. 7 illustrates an aircraft 700 including a keel 702 positioned on an upper portion 703 of an airframe 704. In FIG. 7, the aircraft 700 further includes a first engine 706, a second engine 708, a right wing 710, a left wing 712, and a vertical stabilizer 714 mounted to an aft portion of the airframe 704. In FIG. 7, the first engine 706 is mounted on a top surface 716 of the right wing 710 and the second engine 708 is mounted on a top surface 718 of the left wing 712. In FIG. 7, the keel 702 is positioned on the upper portion 703 of the airframe 704 between the first engine 706 and the second engine 708. In FIG. 7, the keel 702 is disposed closer to a fore end of the airframe 704 than the vertical stabilizer 714. In other words, the keel 702 is positioned upstream of the vertical stabilizer 714.

In FIG. 7, the keel 702 extends from the upper portion 703 of the airframe 704 above an uppermost point 720 of the first and second engine 706, 708. In some examples, a fan blade 722 of the first engine 706, or a portion thereof, is released on an upwards trajectory that traverses the airframe 704 towards the second engine 708. As such, the keel 702 extends to the highest point of a trajectory of the fan blade 722 that impacts the second engine 708 and, thus, obstructs the trajectory as it traverses the airframe 704. Further, a trajectory of the fan blade 722 that launches above the uppermost point 720 of the first and second engine 706, 708 can avoid contact with the second engine 708 due to a velocity of the fan blade 722 upon release. Additionally, air resistance on the fan blade 722 after release and continued propulsion of the aircraft causes the fan blade 722 to travel slower than the aircraft 700 if the fan blade 722 takes more than about 3 seconds to cross the airframe 704. As a result, the fan blade 722 falls behind the second engine 708 and avoids impact therewith. In some examples, the highest point of the trajectory of the fan blade 722 that impacts the second engine 708 is determined based on simulated blade releases similar to the simulations illustrated in FIGS. 2 and 6. As a result, the keel 702 prevents an object from exiting the first engine 706 and impacting the second engine 708.

FIG. 8 illustrates an aircraft 800 including a first keel 802 positioned on a first wing 816 between a first engine 804 and a second engine 806, a second wing keel 808 positioned on a second wing 818 between a third engine 810 and a fourth engine 812, and a third keel 814 positioned on an airframe 820 between the second engine 806 and the third engine 810. In FIG. 8, the first wing keel 802, the first engine 804, and the second engine 806 are mounted on a bottom surface 822 of the right wing 816. In FIG. 8, the second wing keel 808, the third engine 810, and the fourth engine 812 are mounted on a bottom surface 824 of the left wing 818. In FIG. 8, the airframe keel 814 extends from a bottom surface 826 of the airframe 820. In some other examples, the engines 804, 806, 810, 812 and the keels 802, 808, 814 are positioned on a top surface of the right and left wings 816, 818 and/or the airframe 820.

In FIG. 8, the first wing keel 802 and the second wing keel 808 deflect objects that traverse a portion of the right wing 816 and the left wing 818, respectively. In some examples, the first wing keel 802 prevents objects, such as fan blades, from exiting the first engine 804 and impacting the second engine 806. In some examples, the second wing keel 808 prevents objects, such as fan blades, from exiting the third engine 810 and impacting the fourth engine 812. Further, the airframe keel 814 deflects objects, such as fan blades, that traverse a portion of the airframe 820, which prevents objects from exiting the second engine 806 and impacting the third engine 810.

In some examples, rotor blades of the first, second, third, and fourth engines 804, 806, 810, 812 are positioned within different planes of rotation. In some such examples, the keels 802, 808, 814 extend along the wings 816, 818 and/or the airframe 820 between the different planes of rotation and at least 15 degrees towards an aft end of the aircraft 800 from a trailing plane of rotation and at least 15 degrees towards a fore end of the aircraft 800 from a leading plane of rotation. In FIG. 8, a height of the keels 802, 808, 814 is less than or equal to a diameter of the engines 804, 806, 810, 812 (e.g., a diameter of the rotor blades of the engines 804, 806, 810, 812).

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

From the foregoing, it will be appreciated that example airframe localized keel structures have been disclosed that deflect an object, such as a fan blade or a portion thereof, traversing between engines of an aircraft. In other words, the airframe localized keel structures prevent the object from exiting a first engine and impacting the second engine. As a result, the disclosed airframe localized keel structures protects a first engine in response to a second engine losing a fan blade, which, in turn, maintains propulsion of the aircraft.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

Further aspects of the invention are provided by the subject matter of the following clauses:

1. An aircraft comprising: an airframe, a first engine mounted on a first side of the airframe, a second engine mounted on a second side of the airframe opposite the first side of the airframe, and an airframe keel positioned on at least one of a lower portion of the airframe or an upper portion of the airframe between the first engine and the second engine, the airframe keel to prevent an object from exiting the first engine and impacting the second engine.

2. The aircraft of any preceding clause, wherein the airframe keel includes a protection section and an aerodynamic section, the aerodynamic section including an arc that diminishes in height towards a fore end of the airframe to reduce drag forces on the airframe keel.

3. The aircraft of any preceding clause, wherein the airframe keel is at least one of collapsible, retractable, or detachable.

4. The aircraft of any preceding clause, further including a wing keel positioned between the first engine and a third engine on the first side of the airframe.

5. The aircraft of any preceding clause, wherein the airframe keel is positioned in line with a plane of rotation of fan rotors of the first engine and the second engine.

6. The aircraft of any preceding clause, wherein the airframe keel extends longitudinally along the airframe at least 15 degrees from each side of the plane of rotation of the fan rotors.

7. The aircraft of any preceding clause, wherein a height of the airframe keel is less than or equal to a diameter of fan rotors of the first engine and the second engine.

8. The aircraft of any preceding clause, wherein the first engine and the second engine do not include containment systems.

9. An aircraft comprising: an airframe, engines mounted on opposite sides of the airframe, the engines not including containment systems, and a keel disposed between the engines on an upper surface of the airframe or a lower surface of the airframe, the keel to deflect objects traversing a portion of the airframe.

10. The aircraft of any preceding clause, further including a vertical stabilizer mounted to an aft portion of the airframe, the keel disposed upstream of the vertical stabilizer.

11. The aircraft of any preceding clause, wherein a height of the keel is less than or equal to a diameter of the engines.

12. The aircraft of any preceding clause, wherein the keel includes a first section disposed aft a second section, the first section including a uniform height and the second section including a height that diminishes towards a fore end of the airframe.

13. The aircraft of any preceding clause, wherein the keel is at least one of collapsible, retractable, or detachable relative to the airframe.

14. The aircraft of any preceding clause, wherein the keel is mounted onto the upper surface of the airframe or the lower surface of the airframe via fasteners.

15. The aircraft of any preceding clause, wherein the engines include fan rotors, the keel aligned with a plane of rotation of the fan rotors.

16. The aircraft of any preceding clause, wherein a length of the keel extends along the airframe at least 15 degrees from each side of the plane of rotation of the fan rotors.

17. The aircraft of any preceding clause, wherein a leading edge of the keel includes at least one of a smaller width or height compared to a trailing edge of the keel.

18. A keel apparatus comprising: a protection section including a rectangular cross-section, the protection section to be fixed to a body, the protection section to deflect objects traversing at least a portion of the body, and an aerodynamic section including a first end and a second end, the first end of the aerodynamic section fixed to a leading edge of the protection section, the second end of the aerodynamic section including a reduced height relative to the protection section, the aerodynamic section including at least one arc between the first end and the second end, the second end of the aerodynamic section including a smaller thickness than the protection section to reduce a drag force on the protection section.

19. The keel apparatus of any preceding clause, wherein at least one of the protection section or the aerodynamic section includes an energy absorbing material.

20. The keel apparatus of any preceding clause, wherein the energy absorbing material is a foam honeycomb with a composite skin.

21. An apparatus comprising: a body, first means for propulsion positioned on a first side of the body, second means for propulsion positioned on a second side of the body opposite the first side, the second means for propulsion aligned with the first means for propulsion, at least one of the first means for propulsion or the second means for propulsion not including a containment system, and means for deflecting extending from a lower surface of the body or an upper surface of the body between the first means for propulsion and the second means for propulsion, the means for deflecting to deflect objects traversing at least a portion of the body.

22. The apparatus of any preceding clause, wherein the first and second means for propulsion include a plane of rotation, a length of the means for deflecting to extend longitudinally along the body at least 15 degrees from each side of the plane of rotation.

23. The apparatus of any preceding clause, wherein the means for deflecting is collapsible.

24. An apparatus comprising: a first engine including at least one blade rotation plane, a second engine including the at least one blade rotation plane, and a keel positioned between the first engine and the second engine, the keel aligned with the at least one blade rotation plane of the first engine and the second engine, the keel to deflect objects traversing the at least one blade rotation plane between the first engine and the second engine.

25. The apparatus of any preceding clause, wherein a length of the keel extends at least 15 degrees from opposite sides of the at least one blade rotation plane.

26. The apparatus of any preceding clause, wherein the keel includes a height that is less than or equal to a diameter of the first engine or the second engine.

27. The apparatus of any preceding clause, wherein a leading edge of the keel includes at least one of a smaller width or height compared to a trailing edge of the keel.

28. The apparatus of any preceding clause, wherein the keel is at least one of collapsible or retractable.

29. The apparatus of any preceding clause, wherein the first engine and the second engine do not include containment systems.

What is claimed is:

1. An aircraft comprising:
an airframe;
a first engine mounted on a first side of the airframe;
a second engine mounted on a second side of the airframe opposite the first side of the airframe; and
an airframe keel positioned on at least one of a lower portion of the airframe or an upper portion of the airframe between the first engine and the second engine, the airframe keel to prevent an object from exiting the first engine and impacting the second engine.

2. The aircraft of claim 1, wherein the airframe keel includes a protection section and an aerodynamic section, the aerodynamic section including an arc that diminishes in height towards a fore end of the airframe to reduce drag forces on the airframe keel.

3. The aircraft of claim 1, wherein the airframe keel is at least one of collapsible, retractable, or detachable.

4. The aircraft of claim 1, further including a wing keel positioned between the first engine and a third engine on the first side of the airframe.

5. The aircraft of claim 1, wherein the airframe keel is positioned in line with a plane of rotation of fan rotors of the first engine and the second engine.

6. The aircraft of claim 5, wherein the airframe keel extends longitudinally along the airframe at least 15 degrees from each side of the plane of rotation of the fan rotors.

7. The aircraft of claim 1, wherein a height of the airframe keel is less than or equal to a diameter of fan rotors of the first engine and the second engine.

8. The aircraft of claim 1, wherein the first engine and the second engine do not include containment systems.

9. An aircraft comprising:
an airframe;
engines mounted on opposite sides of the airframe, the engines not including containment systems; and
a keel disposed between the engines on an upper surface of the airframe or a lower surface of the airframe, the keel to deflect objects traversing a portion of the airframe.

10. The aircraft of claim 9, further including a vertical stabilizer mounted to an aft portion of the airframe, the keel disposed upstream of the vertical stabilizer.

11. The aircraft of claim 9, wherein a height of the keel is less than or equal to a diameter of the engines.

12. The aircraft of claim 9, wherein the keel includes a first section disposed aft a second section, the first section including a uniform height and the second section including a height that diminishes towards a fore end of the airframe.

13. The aircraft of claim 9, wherein the keel is at least one of collapsible, retractable, or detachable relative to the airframe.

14. The aircraft of claim 9, wherein the keel is mounted onto the upper surface of the airframe or the lower surface of the airframe via fasteners.

15. The aircraft of claim 9, wherein the engines include fan rotors, the keel aligned with a plane of rotation of the fan rotors.

16. The aircraft of claim 15, wherein a length of the keel extends along the airframe at least 15 degrees from each side of the plane of rotation of the fan rotors.

17. The aircraft of claim 9, wherein a leading edge of the keel includes at least one of a smaller width or height compared to a trailing edge of the keel.

18. A keel apparatus comprising:
a protection section including a rectangular cross-section, the protection section to be fixed to a body, the protection section to deflect objects traversing at least a portion of the body; and
an aerodynamic section including a first end and a second end, the first end of the aerodynamic section fixed to a leading edge of the protection section, the second end of the aerodynamic section including a reduced height relative to the protection section, the aerodynamic section including at least one arc between the first end and the second end, the second end of the aerodynamic section including a smaller thickness than the protection section to reduce a drag force on the protection section.

19. The keel apparatus of claim 27, wherein at least one of the protection section or the aerodynamic section includes an energy absorbing material.

20. The keel apparatus of claim 28, wherein the energy absorbing material is a foam honeycomb with a composite skin.
